(19) United States
(12) Patent Application Publication
(10) Pub. No.: US 2014/0041803 A1
(43) Pub. Date: Feb. 13, 2014

(54) METHOD AND APPARATUS FOR LIQUID TREATMENT OF WAFER SHAPED ARTICLES

(71) Applicants: Takehito KOSHIZAWA, San Jose, CA (US); Noriaki KAMEKAWA, Okinawa (JP); Kei KINOSHITA, Villach (AT); Michael PUGGL, Villach (AT)

(72) Inventors: Takehito KOSHIZAWA, San Jose, CA (US); Noriaki KAMEKAWA, Okinawa (JP); Kei KINOSHITA, Villach (AT); Michael PUGGL, Villach (AT)

(73) Assignee: LAM RESEARCH AG, Villach (AT)

(21) Appl. No.: 13/569,923

(22) Filed: Aug. 8, 2012

(51) Int. Cl. B44C 1/22

(52) U.S. Cl. 156/345.19; 156/345.23

(57) ABSTRACT

In an apparatus and method for treating a wafer-shaped article, a rotary chuck is configured to hold a wafer-shaped article of a predetermined diameter such that a surface of the wafer-shaped article facing the rotary chuck is spaced from an opposing peripheral surface of the rotary chuck. The opposing peripheral surface comprises a first surface overlapping an outer peripheral edge of a wafer-shaped article when positioned on the spin chuck and a second surface positioned radially inwardly of the first surface and meeting the first surface at an interface that is radially inward of and substantially concentric with a wafer-shaped article when positioned on the rotary chuck. The second surface is substantially more hydrophobic than the first surface.

### BACKGROUND OF THE INVENTION

1. Field of the Invention

The invention relates to a method and apparatus for liquid treatment of wafer-shaped articles.

2. Description of Related Art

Liquid treatment includes both wet etching and wet cleaning, wherein the surface area of a wafer to be treated is wetted with a treatment liquid and a layer of the wafer is thereby removed or impurities are thereby carried off. A device for liquid treatment is described in U.S. Pat. No. 4,903,717. In this device the distribution of the liquid may be assisted by the rotational motion imparted to the wafer.

Single wafer wet processing of semiconductor wafers typically proceeds through a series of process modules, each of which contains a group of spin chucks such as that described in the above-referenced U.S. patent. One typical process stage is referred to as “bevel etch”, and involves etching the back side of a silicon wafer as well as the outer periphery of the front or device side of the wafer. Etching of the device side is to a controlled extent of only a few millimeters at the outer periphery of the wafer.

A spin chuck adapted to perform bevel etching of semiconductor wafers is described in commonly-owned U.S. Pat. No. 7,172,674, and certain aspects of that spin chuck are illustrated in present FIGS. 1 and 2. As shown in FIG. 1, a chuck 11 supports a wafer W by gas flow in the direction of the arrows G, according to the Bernoulli principle. Thus, pins 53 restrain the wafer W laterally, whereas the wafer is held to the chuck by the counterbalancing pressures created by the gas flow beneath the wafer.

Chuck 11 is equipped with a ring 2 whose upper surface is spaced from the underside of wafer W by a defined small gap 15. As shown in FIG. 2, as etching liquid L is dispensed onto the upwardly facing back side of wafer W, it also flows around the edge of wafer W and is drawn into gap 15 by capillary action. Ingress of etching liquid L halts at the radially inner edge of ring 15, where a meniscus M is formed. The radial extent d of etching effected on the device or downwardly facing side of wafer W is therefore defined and limited by the extent of overlap between wafer W and ring 15.

While such a device can form a highly accurate bevel edge, the process window within which optimum results are achieved is relatively narrow. Factors potentially affecting the quality and uniformity of the bevel etch, and its consistency from one wafer to the next, include the nature of the material to be removed from the wafer surface, the composition and physical properties of the etching liquid, the process temperature, the size of the gap 15, the diameter of the wafer being processed, and the speed of rotation of the chuck.

It would therefore be desirable to provide a method and apparatus for performing bevel etch with high accuracy and reproducibility over a broader process window.

### SUMMARY OF THE INVENTION

Thus in one aspect, the present invention relates to an apparatus for treating a wafer-shaped article, comprising a rotary chuck configured to hold a wafer-shaped article of a predetermined diameter such that a surface of the wafer-shaped article facing the rotary chuck is spaced from an opposing peripheral surface of the rotary chuck. The opposing peripheral surface comprises a first surface overlapping an outer peripheral edge of a wafer-shaped article when positioned on the spin chuck and a second surface positioned radially inwardly of the first surface and meeting the first surface at an interface that is radially inward of and substantially concentric with a wafer-shaped article when positioned on the rotary chuck. The second surface is substantially more hydrophobic than the first surface.

In preferred embodiments of the apparatus according to the present invention, the second surface has a contact angle at least 30° greater than a contact angle of the first surface, preferably at least 60° greater, more preferably at least 90° greater, and still more preferably at least 120° greater.

In preferred embodiments of the apparatus according to the present invention, the rotary chuck comprises a circular series of pins movable to a closed position in which the pins contact an edge of a wafer-shaped article when positioned on the rotary chuck. Contact surfaces of the circular series of pins describe a circle of the predetermined diameter.

In preferred embodiments of the apparatus according to the present invention, the predetermined diameter is 200 mm, 300 mm or 450 mm.

In preferred embodiments of the apparatus according to the present invention, the interface is located 0.2-7 mm radially inward of an outer edge of a wafer-shaped article when positioned on the rotary chuck, preferably 0.3-5 mm, and more preferably 0.5-4 mm.

In preferred embodiments of the apparatus according to the present invention, the second surface extends radially inwardly from the interface over a distance of at least 1 mm.

In preferred embodiments of the apparatus according to the present invention, the second surface has an induced surface roughness imparting thereto a contact angle in excess of 150°.

In preferred embodiments of the apparatus according to the present invention, the first surface has a contact angle less than 40° and the second surface has a contact angle greater than 100°.

In preferred embodiments of the apparatus according to the present invention, the first surface comprises a quartz material.

In preferred embodiments of the apparatus according to the present invention, the second surface comprises a perfluoroalkoxy polymer.

In preferred embodiments of the apparatus according to the present invention, the first and second surfaces are formed on a ring mounted on said rotary chuck coaxially with an axis of rotation of said rotary chuck.

In preferred embodiments of the apparatus according to the present invention, the second surface comprises a nano-pin film having upwardly projecting pins whose width at a tip thereof is less than 10 nm.

In preferred embodiments of the apparatus according to the present invention, each of the circular series of pins comprises an eccentric gripper that is moveable upon pivoting of the series of pins from a radially inward position engaging a wafer-shaped article to a radially outward position releasing a wafer-shaped article.

In preferred embodiments of the apparatus according to the present invention, the second surface comprises a coating of hydrophobic material.

In preferred embodiments of the apparatus according to the present invention, the second surface is a face of a structural element formed from a hydrophobic material.

In another aspect, the present invention relates to a ring for use in an apparatus for treating a wafer-shaped article, comprising an annular structural member having a generally flat upper surface, wherein the flat upper surface comprises a first peripheral region and a second region positioned radially inwardly of the first peripheral region and meeting the first peripheral region at an interface substantially concentric with a central axis of the annular structural member. The second region is substantially more hydrophobic than the first peripheral region.

In preferred embodiments of the ring according to the present invention, the second region has a contact angle at least 30° greater than a contact angle of the first peripheral region, preferably at least 60° greater, more preferably at least 90° greater, and still more preferably at least 120° greater.

In preferred embodiments of the ring according to the present invention, the first peripheral region has a contact angle less than 40° and the second region has a contact angle greater than 100°.

In yet another aspect, the present invention relates to a method of treating a wafer-shaped article, which involves positioning a wafer-shaped article on a rotary chuck, and supplying a hydrophilic etching liquid into a gap between the periphery of the wafer-shaped article and an opposing peripheral surface of the rotary chuck. The opposing peripheral surface comprises a first surface overlapping an outer peripheral edge of a wafer-shaped article and a second surface positioned radially inwardly of the first surface and meeting the first surface at an interface that is radially inward of and substantially concentric with the wafer-shaped article. The second surface is substantially more hydrophobic than the first surface, so as to limit the radially inward ingress of the liquid etchant, thereby to etch the wafer-shaped article selectively in regions facing the first surface without etching the article in regions facing the second surface.

In preferred embodiments of the method according to the present invention, the second surface has a contact angle at least 30° greater than a contact angle of the first surface, preferably at least 60° greater, more preferably at least 90° greater, and still more preferably at least 120° greater.

In preferred embodiments of the method according to the present invention, the rotary chuck comprises a circular series of pins movable to a closed position in which the pins contact an edge of the wafer-shaped article. Contact surfaces of the circular series of pins describe a circle of the predetermined diameter.

In preferred embodiments of the method according to the present invention, the wafer-shaped article has a diameter of 200 mm, 300 mm or 450 mm.

In preferred embodiments of the method according to the present invention, the interface is located 0.2-7 mm radially inward of the outer edge of the wafer-shaped article, preferably 0.3-5 mm, and more preferably 0.5-4 mm.

In preferred embodiments of the method according to the present invention, the second surface extends radially inwardly from the interface over a distance of at least 1 mm.

In preferred embodiments of the method according to the present invention, the second surface has an induced surface roughness imparting thereto a contact angle in excess of 150°.

In preferred embodiments of the method according to the present invention, the first surface has a contact angle less than 40° and the second surface has a contact angle greater than 100°.

In preferred embodiments of the method according to the present invention, the first surface comprises a quartz material.

In preferred embodiments of the method according to the present invention, the second surface comprises a perfluoroalkoxy polymer.

In preferred embodiments of the method according to the present invention, the first and second surfaces are formed on a ring mounted on the rotary chuck coaxially with an axis of rotation of the rotary chuck.

In preferred embodiments of the method according to the present invention, the second surface comprises a nano-pin film having upwardly projecting pins whose width at a tip thereof is less than 10 nm.

### BRIEF DESCRIPTION OF THE DRAWINGS

Other objects, features and advantages of the invention will become more apparent after reading the following detailed description of preferred embodiments of the invention, given with reference to the accompanying drawings, in which:

FIG. 1 is a schematic perspective side view of a prior art spin chuck for performing a bevel etch on a semiconductor wafer;

FIG. 2 is a detail of the capillary ring of the chuck of FIG. 1;

FIG. 3 is a perspective view from above of a chuck according to a first embodiment of the invention;

FIG. 4 is a partial axial section through the chuck depicted in FIG. 3, taken along the line IV-IV of FIG. 3, with a wafer in position as indicated in broken line;

FIG. 5 is an enlarged view of the detail V designated in FIG. 4; and

FIG. 6 is a view like that of FIG. 5, of another embodiment of the apparatus according to the present invention.

### DETAILED DESCRIPTION OF PREFERRED EMBODIMENTS

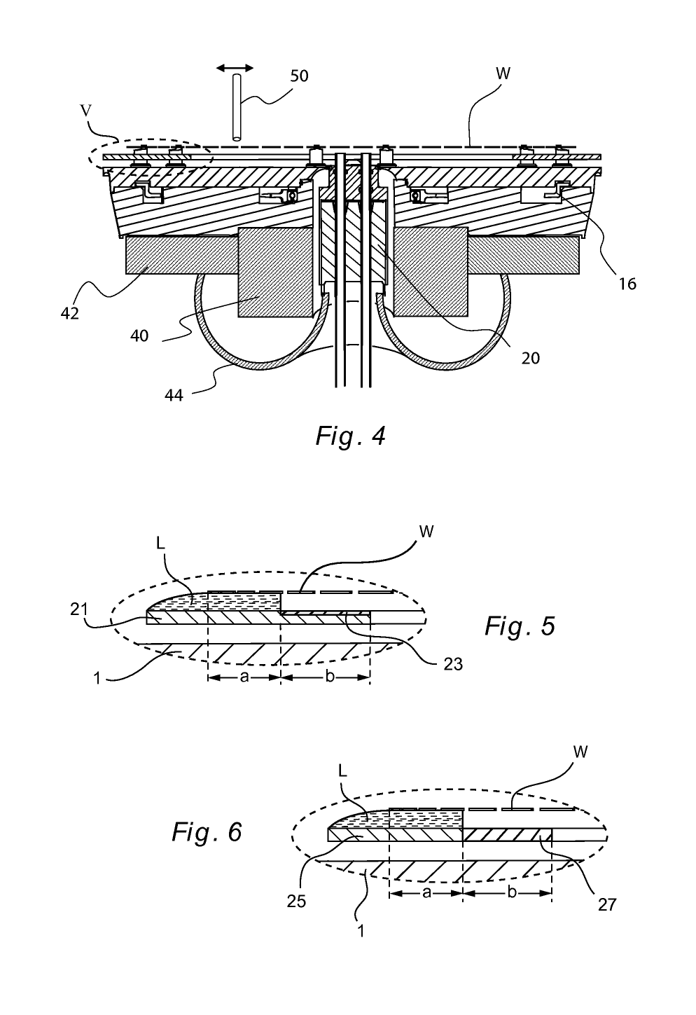

Referring now to the drawings, FIGS. 3 and 4 depict a spin chuck 1 that holds a wafer thereon in a predetermined orientation, which is preferably such that the major surfaces of disposed horizontally or within ±20° of horizontal. Spin chuck 1 may for example be a chuck that operates according to the Bernoulli principle, as described for example in U.S. Pat. No. 4,903,717.

Chuck 1 includes a series of gripping pins, which in this embodiment are six in number, designated 10-1 through 10-6. Gripping pins 10-1 to 10-6 prevent the wafer from sliding laterally off the chuck. In this embodiment, the upper portions of gripping pins 10-1 to 10-6 also provide subjacent support for wafer W, and thus the chuck need not operate according to the Bernoulli principle and need not be adapted to supply a gas cushion beneath wafer. In particular, each gripping pin comprises an uppermost gripping portion that extends vertically from the cylindrical pin base, generally along an axis that is offset in relation to the rotation axis of the cylindrical pin base. The upper gripping portions furthermore each comprise a lateral recess or cut-out that is designed to accommodate the peripheral edge of a wafer, as is described in greater detail below.

Gripping pins 10-1 to 10-6 project upwardly through holes formed in a ring 20, which will be described in greater detail below. Ring 20 is mounted to the chuck 1 by a series of posts (not shown), with one post preferably being located between each pair of gripping pins 10-1 to 10-6.

Gripping elements 10-1 to 10-6 are provided with eccentrically mounted grippers. The gripping elements are conjointly rotated about their cylindrical axes by a tooth gear 16 that is in meshing engaging with all of the gripping elements. The eccentric grippers are thus moved in concert between a radially inner closed position in which a wafer W is secured, to a radially outer open position in which the wafer W is released. Gripping elements 10-1 to 10-6 can be made as described in commonly-owned U.S. application Ser. No. 12/668,940 (corresponding to WO 2009/010394, or as described in commonly-owned U.S. application Ser. No. 12/642,117, filed Dec. 18, 2009). Gripping elements 10-1 to 10-6 thus comprise an eccentric uppermost portion that contacts wafer W, projecting from a base that is mounted for pivotal movement about its central axis. In particular, a ring gear 16 is centered on the underside of the chuck upper body, and simultaneously engages via its peripheral gear teeth with gear teeth formed on the base of each of the pins 10-1 to 10-6. Pins 10-1 to 10-6 are evenly distributed about the periphery of spin chuck 1, with at least three and preferably six such pins 10 being provided.

Although not shown in the figures, the spin chuck may be surrounded by a process chamber, which may be a multi-level process chamber as described in commonly-owned U.S. Pat. No. 7,837,803 (corresponding to WO 2004/084278). The spin chuck can be positioned at the selected level by moving the chuck axially relative to the stationary surrounding chamber, or by moving the surrounding chamber axially relative to the axially-stationary chuck, as described in connection with FIG. 4 of U.S. Pat. No. 6,536,454.

As shown in greater detail in FIG. 4, the dispensing assembly comprises a non-rotating (stationary) nozzle head 20 whose nozzles penetrate the cover of the heating assembly, as described below. In this embodiment, four nozzles 22, 24, 26, 28 protrude through the nozzle head. Pipes feeding these nozzles are each connected to different fluid sources. For example, nozzle 22 might supply deionized water, central nozzle 24 might supply dry nitrogen gas, and nozzle 26 might supply a process liquid. The nozzles 22, 24, 26, 28 are directed towards the downwardly facing surface of the wafer.

Spin chuck 1 is mounted to the rotor of a hollow-shaft motor 40 (schematically shown in FIG. 4), and the stationary nozzle head 20 penetrates through a central opening of the spin chuck 1. The stator of the hollow-shaft motor 40 is mounted to the mounting plate 42 (schematically shown in FIG. 3). Nozzle head 20 and mounting plate 42 are mounted to the same stationary frame 44 (schematically shown in FIG. 3).

An upper liquid dispenser 50 supplies treatment liquid from above, and can incorporate a plurality of different liquid dispensing nozzles for dispensing a variety of different treatment liquids, as described for example in commonly-owned U.S. Pat. No. 7,891,314 (corresponding to WO 2006/008236). Upper liquid dispenser 50 is preferably displaceable radially of the wafer W, to aid in spreading treatment liquid over the entire upwardly facing surface of wafer W as it is rotated on the spin chuck.

Ring 20 comprises surfaces of markedly different wettability, to limit the extent of etching of the wafer surface that faces the chuck in a different manner than does the prior art described above. In the depicted embodiment, this is the downwardly facing surface of the wafer W; however, the present invention may also be applied to chucks in which the wafer is suspended hanging downwardly from the rotary chuck body, in which case the bevel etch is performed on the upwardly facing wafer surface. In either case, this will be the device or front side of the wafer.

A given chuck 11 is designed for holding a wafer of a particular diameter. The gripping surfaces of pins 10-1 to 10-6, when in their radially inner closed position, thus describe a circle of that diameter. Chucks for wafers currently in commercial production are designed to hold wafers of 200 mm or 300 mm, while wafers of 450 mm will be the next generation.

Thus, with reference to FIGS. 5 and 6, ring 20 will be formed in one embodiment of a relatively hydrophilic material 21, and provided on a radially inner surface thereof with a relatively hydrophobic coating 23. For example, ring 20 may be formed of quartz, which is highly hydrophilic, and provided on its inner periphery with a coating 23 of perfluoroalkoxy (PFA) polymer, which is highly hydrophobic.

The terms wettability, hydrophilic and hydrophobic as used herein can be expressed in a quantitative manner by the contact angle of the surface in question. In general, a hydrophobic surface forms a contact angel with water in the presence of air that is above 90°, whereas a hydrophilic surface forms a contact angel with water in the presence of air that is below 90°.

The contact angle referred to herein is understood to mean the static contact angle between the surface in question and a 5 μl drop of deionized water in an air atmosphere, as measured after one minute by a goniometer and commercially available image analysis software. Variability in contact angles so measured is minor, and is removed altogether when the disparate surfaces are characterized in terms of a difference in contact angle.

The first surface 21, 25 may be formed of any material that is relatively hydrophilic. Preferably the first surface has a contact angle less than 90°, which is normally considered the definition of a hydrophilic surface; however, the first surface may have a contact angle greater than 90°, provided that the second surface has a substantially greater contact angle.

In FIG. 6, second surface 27 is a face of a structural element forming a part of ring 20, and is made of a hydrophobic polymer, for example a polyimide of the class marketed by DuPont under the VESPEL® trade name.

The contact angle of the first and second surfaces is determined not only by the material of those surfaces but also by the surface topography of those surfaces. For example, engineered surfaces may simulate the “lotus effect”, and display contact angles in excess of 150° (superhydrophobic) and even in excess of 160° (ultrahydrophobic). In that case the material itself could be hydrophilic when in a smooth film state, yet display an ultrahydrophobic surface when formed as nanostructures that trap air beneath any contacting liquid.

An example of a surface having an engineered nano-pin structure are the deposited brucite-type cobalt hydroxide (BCH, Co(OH)_{1.13}Cl_{0.09}(CO₃)_{0.39}0.05H₂O) films coated with lauric acid, as described in Hosono et. al., “Superhydrophobic Perpendicular Nanopin Film by the Bottom-Up Process”, J. Am. Chem. Soc. 2005, 127, 13458-13459.

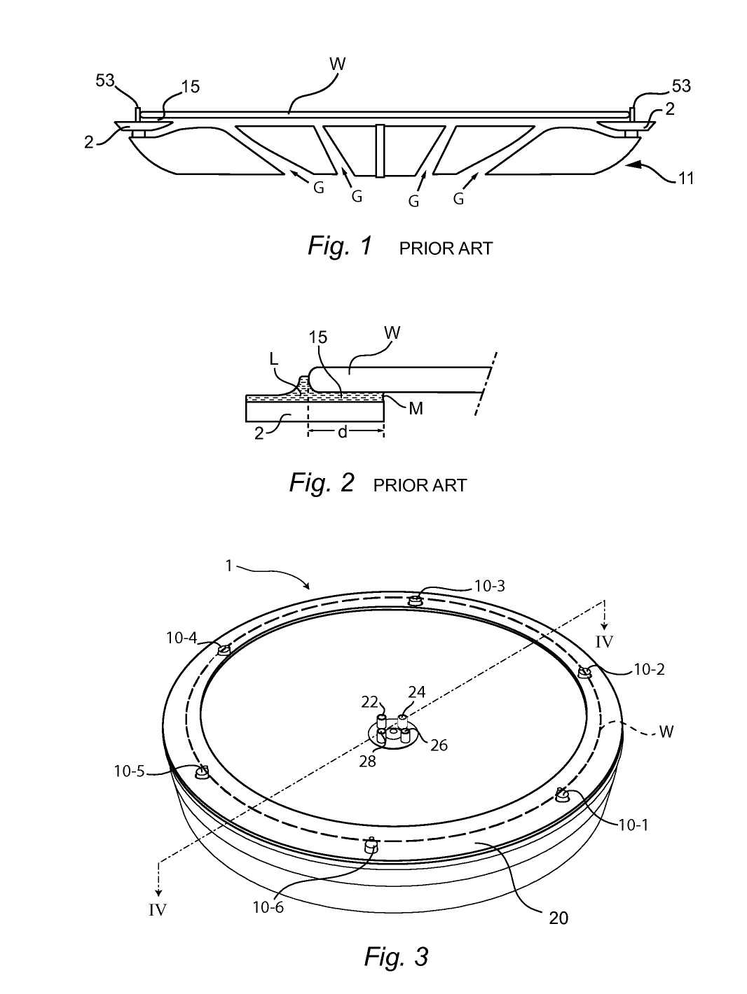

Ring 20 is described in the foregoing embodiments in conjunction with a so-called “double-sided” chuck, which is a chuck provided with gripping pins such that different process fluids may be applied to both sides of a wafer simultaneously or sequentially. However, other preferred embodiments of the present invention utilize a ring 20 as described above in combination with a chuck operating on the Bernoulli principle, in which case such a chuck could be as described above in connection with FIG. 1 and U.S. Pat. No. 7,172,674, except that the ring 2 of FIG. 1 would be replaced by a ring 20 as described above, and the behavior of the etching liquid in the gap between ring 20 and the wafer W would be as described in connection with FIGS. 5 and 6 rather than FIG. 2.

In use, the ingress of the relatively hydrophilic etching liquid L is halted when the liquid L reaches the interface between the hydrophilic surface 21, 25 and the hydrophobic surface 23, 27, and the liquid L thus does not reach the radially inner edge of the ring 20, in contrast to the prior art discussed above. It has been found that this technique permits excellent and reproducible bevel etching over a wider process window than in the prior art discussed above. Thus, in FIGS. 5 and 6, the extent of etching is the overlap between the wafer W and only the hydrophilic surface 21, 25. That distance “a” is 0.2-7 mm, preferably 0.3-5 mm, and more preferably 0.5-4 mm. The distance “b” denoted in FIGS. 5 and 6 is the radial extent of the hydrophobic surface 23, 27. That distance is not critical, but is preferably greater than 1 mm. Moreover, the hydrophobic surface need not extend all the way to the radially inner edge of ring 20 or such other chuck structure in which it is embodied.

While the present invention has been described in connection with various preferred embodiments thereof, it is to be understood that those embodiments are provided merely to illustrate the invention, and should not be used as a pretext to limit the scope of protection conferred by the true scope and spirit of the appended claims.

What is claimed is:

1. Apparatus for treating a wafer-shaped article, comprising:
a rotary chuck configured to hold a wafer-shaped article of a predetermined diameter such that a surface of the wafer-shaped article facing said rotary chuck is spaced from an opposing peripheral surface of the rotary chuck;
wherein said opposing peripheral surface comprises a first surface overlapping an outer peripheral edge of a wafer-shaped article when positioned on the spin chuck and a second surface positioned radially inwardly of said first surface and meeting said first surface at an interface that is radially inward of and substantially concentric with a wafer-shaped article when positioned on said rotary chuck; and
wherein said second surface is substantially more hydrophobic than said first surface.

2. The apparatus according to claim 1, wherein said second surface has a contact angle at least 30° greater than a contact angle of said first surface, preferably at least 60° greater, more preferably at least 90° greater, and still more preferably at least 120° greater.

3. The apparatus according to claim 1, wherein said rotary chuck comprises a circular series of pins movable to a closed position in which said pins contact an edge of a wafer-shaped article when positioned on said rotary chuck, and wherein contact surfaces of said circular series of pins describe a circle of said predetermined diameter.

4. The apparatus according to claim 1, wherein said predetermined diameter is 200 mm, 300 mm or 450 mm.

5. The apparatus according to claim 1, wherein said interface is located 0.2-7 mm radially inward of an outer edge of a wafer-shaped article when positioned on said rotary chuck, preferably 0.3-5 mm, and more preferably 0.5-4 mm.

6. The apparatus according to claim 1, wherein said second surface extends radially inwardly from said interface over a distance of at least 1 mm.

7. The apparatus according to claim 1, wherein said second surface has an induced surface roughness imparting thereto a contact angle in excess of 150°.

8. The apparatus according to claim 1, wherein said first surface has a contact angle less than 40° and said second surface has a contact angle greater than 100°.

9. The apparatus according to claim 1, wherein said first surface comprises a quartz material.

10. The apparatus according to claim 1, wherein said second surface comprises a perfluoroalkoxy polymer.

11. The apparatus according to claim 1, wherein said first and second surfaces are formed on a ring mounted on said rotary chuck coaxially with an axis of rotation of said rotary chuck.

12. The apparatus according to claim 1, wherein said second surface comprises a nano-pin film having upwardly projecting pins whose width at a tip thereof is less than 10 nm.

13. A ring for use in an apparatus for treating a wafer-shaped article, comprising:
an annular structural member having a generally flat upper surface, wherein said flat upper surface comprises a first peripheral region and a second region positioned radially inwardly of said first peripheral region and meeting said first peripheral region at an interface substantially concentric with a central axis of said annular structural member; and
wherein said second region is substantially more hydrophobic than said first peripheral region.

14. The ring according to claim 13, wherein said second region has a contact angle at least 30° greater than a contact angle of said first peripheral region, preferably at least 60° greater, more preferably at least 90° greater, and still more preferably at least 120° greater.

15. The ring according to claim 13, wherein said first peripheral region has a contact angle less than 40° and said second region has a contact angle greater than 100°.
